(19) United States
(12) Patent Application Publication
(10) Pub. No.: US 2023/0062222 A1
(43) Pub. Date: Mar. 2, 2023

(54) Multifunction Fan System and Method of Using Same

(71) Applicant: Spencer E. Bray, Reno, NV (US)

(72) Inventor: Spencer E. Bray, Reno, NV (US)

(21) Appl. No.: 17/462,900

(22) Filed: Aug. 31, 2021

(51) Int. Cl. F24F 7/013

(52) U.S. Cl. CPC F24F 7/013; F24F 2110/10

(57) ABSTRACT

A fan system may include at least one fan unit configured to be mounted in a window opening, the at least one fan unit including a blower unit configured to blow air through the window opening. The fan system may further include a controller including a device processor and a computer readable medium having stored thereon instructions, executable by the device processor, for performing the following steps: receiving weather forecast data; and controlling operation of the at least one fan unit based on the received weather forecast data. Operation of the at least one fan unit may be controlled to effectuate healthy air exchange within the household envelope.

### BACKGROUND

The present embodiments relate generally to climate control fan systems and, in particular, to systems including self-contained, window-mounted fan units.

Fan systems have been developed that are configured to be mounted in windows. However, most of these systems require the window to be opened a large amount. In addition, fan systems have been developed that are controllable based on indoor sensors, outdoor sensors, thermostat data, and/or current weather data. These control parameters are current. In other words, the fan systems are controlled in realtime based on current detected conditions. Such systems do not account for future conditions, such as forecasted weather data.

There is a need in the art for a system and method that addresses the shortcomings discussed above.

### SUMMARY

In one aspect, the present disclosure is directed to a fan system including at least one fan unit configured to be mounted in a window opening, the at least one fan unit including a blower module configured to blow air through the window opening. The fan system may further include a controller including a device processor and a computer readable medium having stored thereon instructions, executable by the device processor, for performing the following steps: receiving weather forecast data; and controlling operation of the at least one fan unit based on the received weather forecast data.

In another aspect, the present disclosure is directed to a window-mounted fan unit. The fan unit may include a trans-window duct configured to permit flow of air between a window edge and a window frame and a housing including one or more blower units and a movable air flow director configured to selectively determine whether air delivered through the one or more blower units is drawn from a first side of the window or from a second side of the window.

In another aspect, the present disclosure is directed to a method of operating a fan system. The method may include, with a controller having a device processor and a non-transitory computer readable medium including instructions executable by the device processor, receiving weather forecast data and, based on the received weather forecast data, controlling operation of at least one fan unit configured to be mounted in a window opening, the at least one fan unit including a blower module configured to blow air through the window opening.

Other systems, methods, features, and advantages of the embodiments will be, or will become, apparent to one of ordinary skill in the art upon examination of the following figuresand detailed description. It is intended that all such additional systems, methods, features, and advantages be included within this description and this summary, be within the scope of the embodiments, and be protected by the following claims.

### BRIEF DESCRIPTION OF THE DRAWINGS

The embodiments can be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic exploded view of fan unit according to an embodiment;

FIG. 2 is a schematic indoor view of a fan unit installed in a window according to an embodiment;

FIG. 3 is a schematic outdoor view of a fan unit installed in a window according to an embodiment;

FIG. 4 is a schematic side view of a fan unit according to an embodiment;

FIG. 5 is an exploded, cut-away, cross-sectional view of a fan unit according to an embodiment;

FIG. 6 is a schematic perspective view of a fan unit with an interior panel removed, revealing internal components, with an air deflector positioned in a fresh air flow position;

FIG. 7 is a schematic perspective view of the fan unit of FIG. 6 with the air deflector positioned in a recirculation air flow position;

FIG. 8 is another schematic perspective view of the fan unit of FIGS. 6 and 7, with the air deflector positioned in the recirculation air flow position;

FIG. 9 is a schematic interior view of a fan unit illustrating a removable air filter;

FIG. 10 is a schematic diagram of a house with a fan system including multiple window-mounted fan units working together to regulate temperatures within the house to account for unbalanced interior temperatures due to uneven sun exposure;

FIG. 11 is a schematic view of a personal electronic device with graphics associated with controlling operation of a fan system according to an embodiment;

FIG. 12 is a schematic diagram of a fan system according to an embodiment;

FIG. 13 is a flowchart illustrating a method of controlling a fan unit based on a variety of received data inputs; and

FIG. 14 is a flowchart illustrating a method of controlling a fan unit based on received weather forecast data.

### DETAILED DESCRIPTION

As used herein, the term “fixedly attached” shall refer to two components joined in a manner such that the components may not be readily separated (for example, without destroying one or both components). The term “removably attached” shall refer to components that are attached to one another in a readily separable manner (for example, with fasteners, such as bolts, screws, etc.).

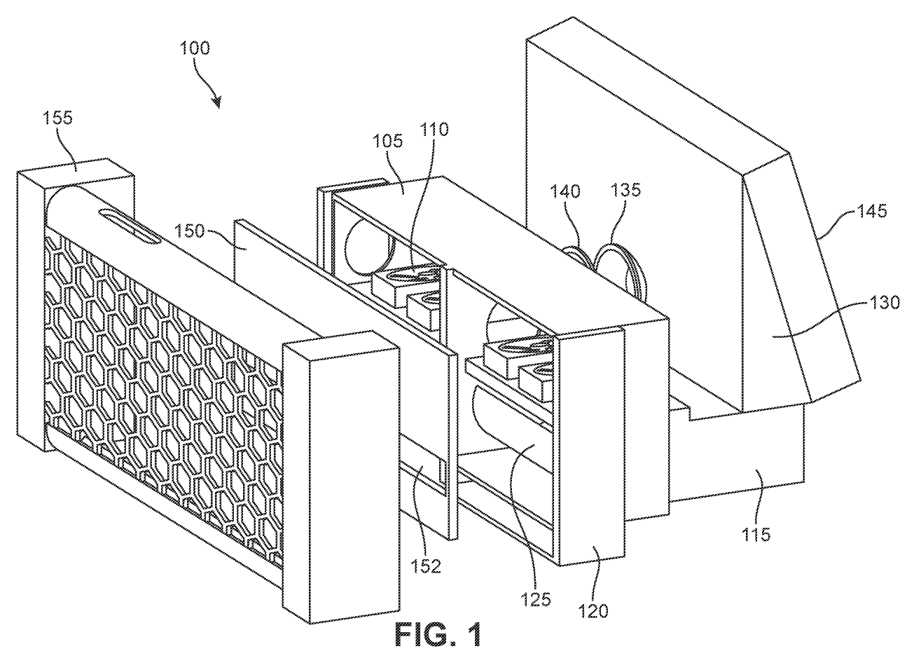

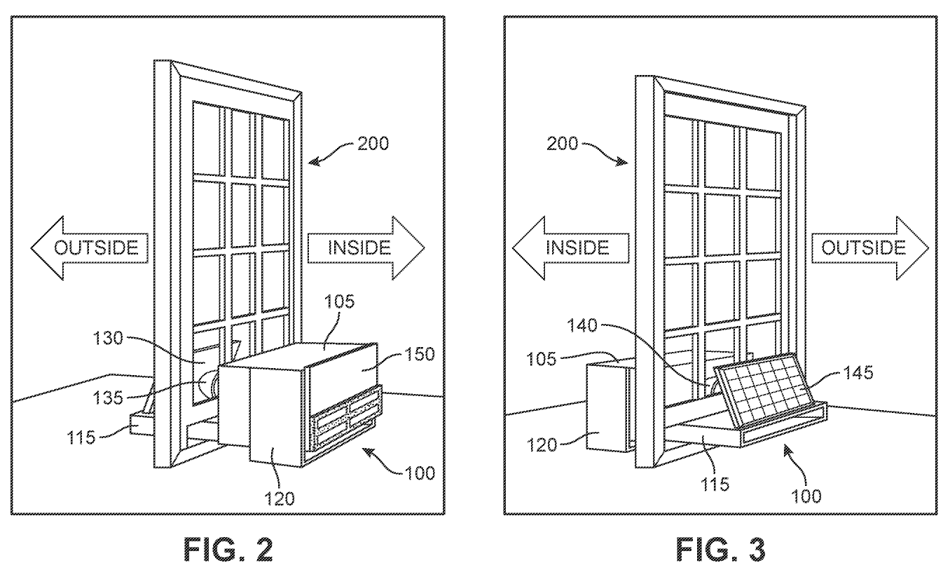

The disclosed fan system includes one or more fan units configured to be mounted in a window opening. FIGS. 1-9 provide schematic illustrations of such a fan unit. FIG. 1 is a schematic exploded view of fan unit according to an embodiment. As shown in FIG. 1, a window-mounted fan unit 100 may include a trans-window duct 115 configured to permit flow of air between a window edge and a window frame. For example, if mounted at the bottom of a partially opened house window, trans-window duct 115 may provide a passage underneath the window sash between a first side of the window to a second side of the window, e.g., between an outdoor environment and an indoor environment. Trans-window duct 115 may have any suitable shape. For example, as shown in FIG. 1, trans-window duct 115 may have a substantially rectangular cross-sectional shape. Having a reduced height, trans-window duct 115 may enable the window to remain only partially open when fan unit 100 is mounted therein. (See. FIGS. 2 and 3.)

In addition, as also shown in FIG. 1, fan unit 100 may include a housing 105 including one or more blower units 110. Blower units 110 may be any suitable type of fan devices. Although the accompanying drawings illustrate blower units 110 as conventional rotary fans, other types of blower devices may be used, such as turbine blowers, centrifugal blowers, positive displacement blowers, rotary vane blowers, etc. In addition, any suitable number of blower units may be used. The number, size, and flowrate/performance specifications of the blower units may be selected based on a number of factors, such as the size of the window opening, the size of the compartment (e.g., household room) enclosed by the window, the overall size of the house, etc. It will be understood that, in some embodiments, blower units 110 may be reversible flow units that may controllably direct flow in either direction.

Also disposed within housing 105 may be a flow directing flow director 125 configured to selectively determine whether air delivered through blower units 110 is

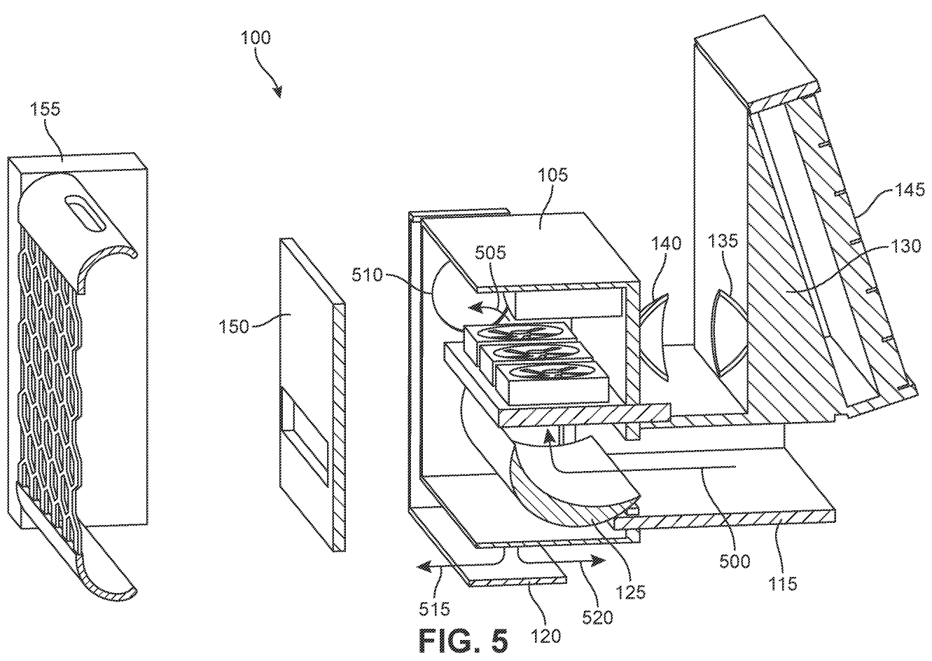

In some embodiments, fan unit 100 may also include a movable flow director 125 disposed within housing 105. Flow director 125 may be movable to select whether air delivered to blower units 110 is drawn from a first side of the window or from a second side of the window. For example, flow director 125 may be movable from a first position in which air is drawn from outside the house to a second position in which air is drawn from inside the house and thus, recirculated back into the house. Flow director 125 is shown and discussed in greater detail with respect to FIGS. 5-8.

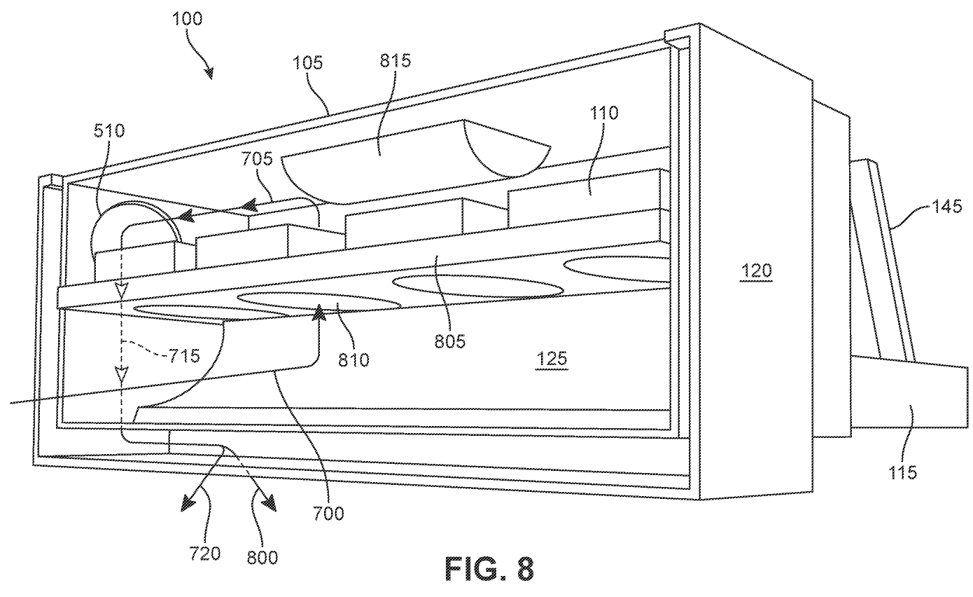

As also shown in FIG. 1, fan unit 100 may include an air guide 120 partially surrounding housing 105 thereby forming an airflow passage between 105 housing and air guide 120. The configuration of air guide 120 is best illustrated in FIG. 8.

In addition, in some embodiments, fan unit 100 may have a substantially U-shaped configuration for mounting around an edge of a window. Looking from the side of fan unit 100, the bottom portion of the “U” is formed by trans-window duct 115. The upright portions of the “U” are formed by housing 105 on one side, and a support wall 130 on the other side. Again, due to the relatively short height of trans-window duct 115, the window may remain mostly closed with fan unit 100 mounted therein, with taller portions of fan unit 100 extending upward on either side of the window. Namely, housing 105 and its internal components extend upward on the inside of the window, while support wall 130 extends upward on the outside of the window.

In order to secure fan unit 100 to the window sash, fan unit 100 may include one or more suction cups. For example, as shown in FIG. 1, a first suction cup 135 may be disposed on support wall 130 and configured to attach to the outside of a window. Additionally, or alternatively, a second suction cup 140 may be disposed on housing 105 and configured to attach to the inside of the window.

In some embodiments, the fan unit may be self-contained. That is, the fan unit may include its own power source independent of any household power source. For example, in some embodiments, the fan unit may include one or more batteries. Additionally, or alternatively, the fan unit may include one or more solar panels. These power sources may be configured to drive the blower unit(s) of the fan unit.

Accordingly, in addition to providing a mounting location for first suction cup 135, support wall 130 may also provide a mounting location for a solar panel 145, as shown in FIG. 1. Solar panel 145 may have any suitable configuration to collect solar energy and convert such energy to electrical power to drive blower units 110. In addition, in some embodiments, such self-contained power may also be used to move flow director 125 from the fresh air flow position to the air recirculation position.

FIG. 1 further shows a housing cover 150 configured to enclose the contents of housing 105. Housing cover 150 includes openings 152 that permit air to be received into the lower compartment of housing 105, but no openings in the top portion of housing cover 150. In addition, fan unit 100 may also include a grill 155 configured to be mounted over the indoor portions of fan unit 100.

In addition, in some embodiments, fan unit 100 may include an evaporative cooling assembly (not shown). Such an evaporative cooling assembly may have any suitable configuration to provide cooling of air directed into the household via fan unit 100.

FIGS. 2 and 3 illustrate the arrangement of fan unit 100 as mounted in a window. In particular, FIG. 2 is a schematic indoor view of a fan unit installed in a window 200. And FIG. 3 is a schematic outdoor view of a fan unit installed in window 200. As shown in FIGS. 2 and 3, housing 105 and air guide 120 may be positioned on the inside of window 200, while support wall 130 and solar panel 145 are positioned on the outside of window 200, with trans-window duct 115 passing through the opening beneath the sash of window 200. Because of the reduced height of trans-window duct 115, the sash of window 200 need only be opened slightly when fan unit 100 is mounted therein.

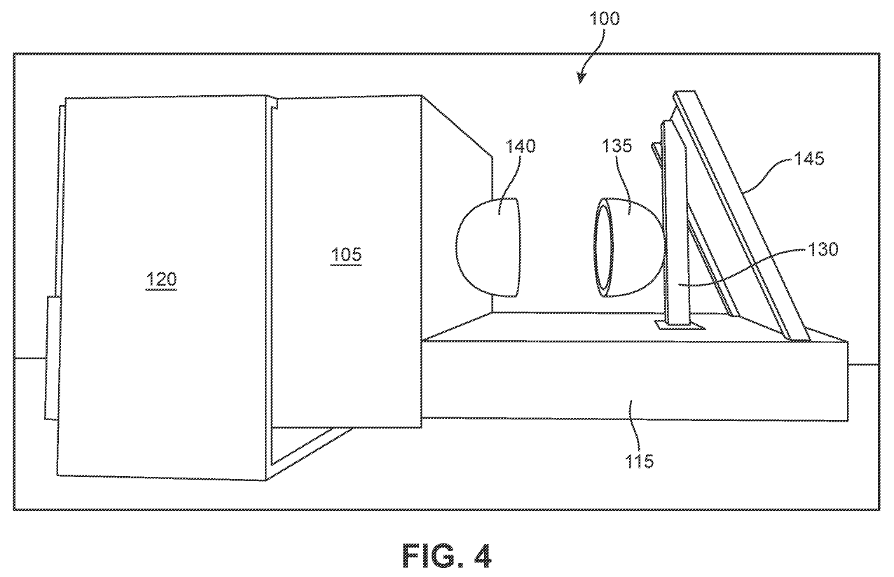

FIG. 4 is a schematic side view of fan unit 100 according to an embodiment. FIG. 4 also provides an unobstructed view of first suction cup 135 and second suction cup 140. As also shown in FIG. 4, fan unit 100 may have a substantially U-shaped configuration with housing 105 on one side, support wall 130 on the other side, and trans-window duct 115 across the bottom.

It will be understood that, although fan unit 100 is shown and discussed as being mounted on the bottom of a vertically sliding window sash, the illustrated fan unit may be mounted on the top of a vertically sliding window sash, or on the side of a horizontally sliding window sash. Further, although the fan units herein are shown and discussed with respect to house windows, it will be understood that the disclosed configurations or variations thereof may be applicable for use in other windows, such as automobile windows.

FIGS. 5-8 illustrate airflow through fan unit 100 in different configurations. FIG. 5 is an exploded, cut-away, cross-sectional view of a fan unit according to an embodiment, wherein the fan unit is configured for fresh air flow. As shown in FIG. 5, flow director 125 may have a crescent shaped cross-section. As further shown in FIG. 5, in this configuration, flow director 125 is oriented to direct an inflow of air (arrow 500) from trans-window duct 115 upward toward blower units 110. Thus, in this configuration, air is drawn from outside the house, rather than inside the house.

As further shown in FIG. 5 by an arrow 505, the air exiting blower units 110 fills the top chamber of housing 105 and exits housing 105 via openings 510 on opposing sidewalls of housing 105 (note: only one of openings 510 is shown). The airflow passes through openings 510 and into the space between housing 105 and air guide 120 along the sides of fan unit 100. The air then flows down and into the passage between air guide 120 and housing 105 at the bottom of fan unit 100, and out into the room of the house, as illustrated by an arrow 515 and arrow 520. It will be noted that, although the figures show air flowing out the exterior facing side (arrow 520), in some embodiments, this exit may be blocked off, so that the air flows only out the interior facing side.

It will also be noted that, the flow of blower units 110 may be reversed, and the flow pattern diagrammed in FIG. 5 may be reversed to provide an exhaust flow. Thus, the “fresh air” configuration and the “exhaust flow” configuration are one in the same. That is, both flows are enabled by the positioning of flow director 125 as shown in FIG. 5.

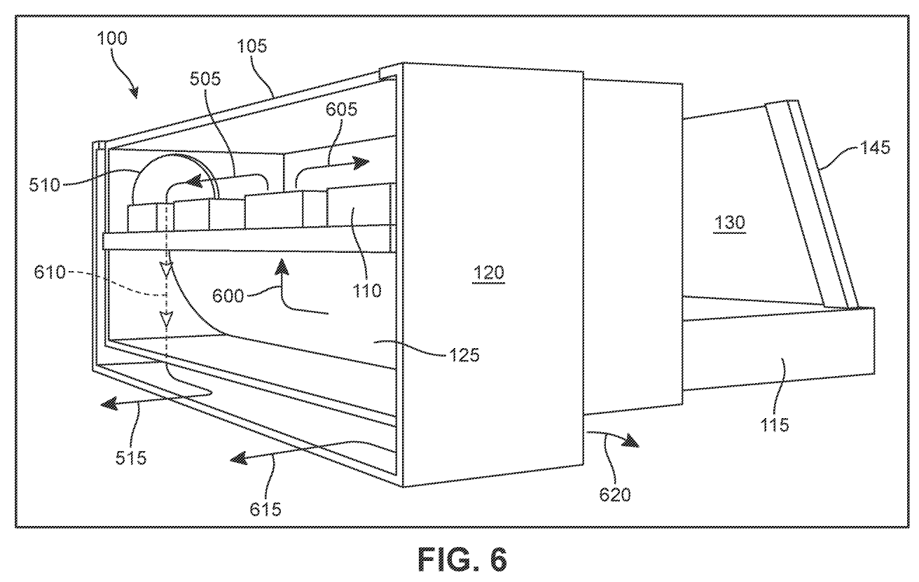

FIG. 6 is a schematic perspective view of a fan unit with the housing cover removed, revealing internal components, with the flow director positioned in a exhaust/fresh air flow position (i.e., the same configuration as shown in FIG. 5). As shown in FIG. 6, in the fresh air flow configuration, air is drawn into trans-window duct 115 (arrow 500), then directed upwards to blower units 110 (arrow 600) by flow director 125. Then, air exits blower units 110 (arrows 505 and 605), and pass through openings 510 in housing 105. Air then flows downward in the passage between housing 105 and air guide 120 (arrow 610), and exits out the bottom of fan unit 100 (arrows 515, 615, and 620).

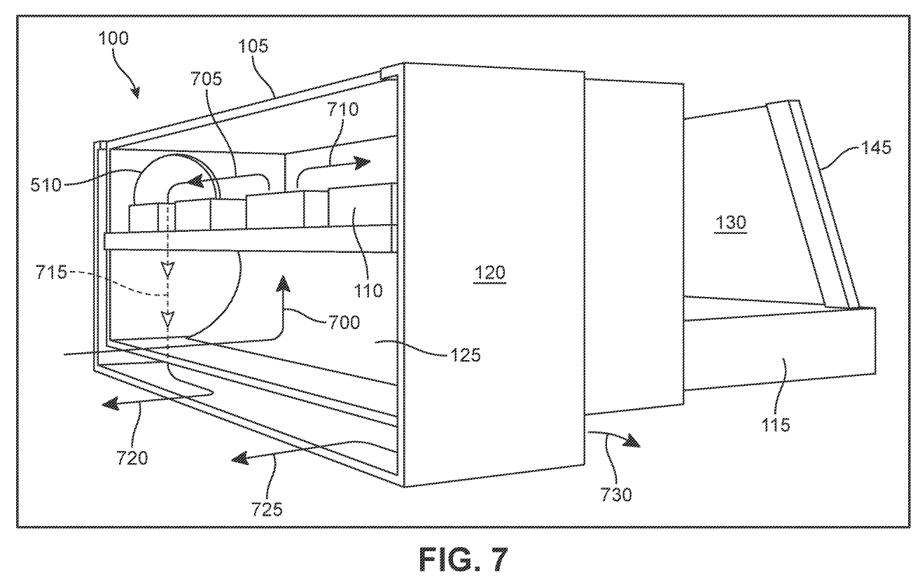

FIG. 7 is a schematic perspective view of the fan unit of FIG. 6 with the flow director positioned in a recirculation air flow position. As shown in FIG. 7, flow director 125 may be movable (e.g., rotatable) to a position in which it directs air to blower units 110 from inside the house (arrow 700). Air then exits blower units 110 (arrows 705 and 710) and proceeds through openings 510 and down the outer passage between the sidewalls of housing 105 and air guide 120 (arrow 715). Air then exits fan unit 100 from the bottom (arrows 720, 725, and 730).

FIG. 8 is another schematic perspective view of the fan unit of FIGS. 6 and 7, with the air deflector positioned in the recirculation air flow position. FIG. 8 illustrates the flow of air out the outdoor facing side of fan unit 100 (arrow 800). Again, in some embodiments, flow in this direction may be blocked off or otherwise minimized by baffles and the like.

As can also be seen in FIG. 8, blower units 110 may be mounted on a partition 805 that separates the upper chamber of housing 105 from the lower chamber of housing 105. As further shown in FIG. 8, partition 805 may include a plurality of openings 810 enabling air flow through partition 805. In some embodiments, partition 805 may include an opening 810 corresponding with each blower unit 110, as shown in FIG. 8. It will be understood, however, that partition 805 may have any number of openings suitable to permit free air flow between the upper and lower chambers of housing 105.

As also shown in FIG. 8, in some embodiments, fan unit 100 may also include an ultraviolet (UV) light/lamp 815 for disinfecting airflow through fan unit 100. UV lamp 815 may have any suitable configuration to provide UV scrubbing of air before the air is delivered into the household.

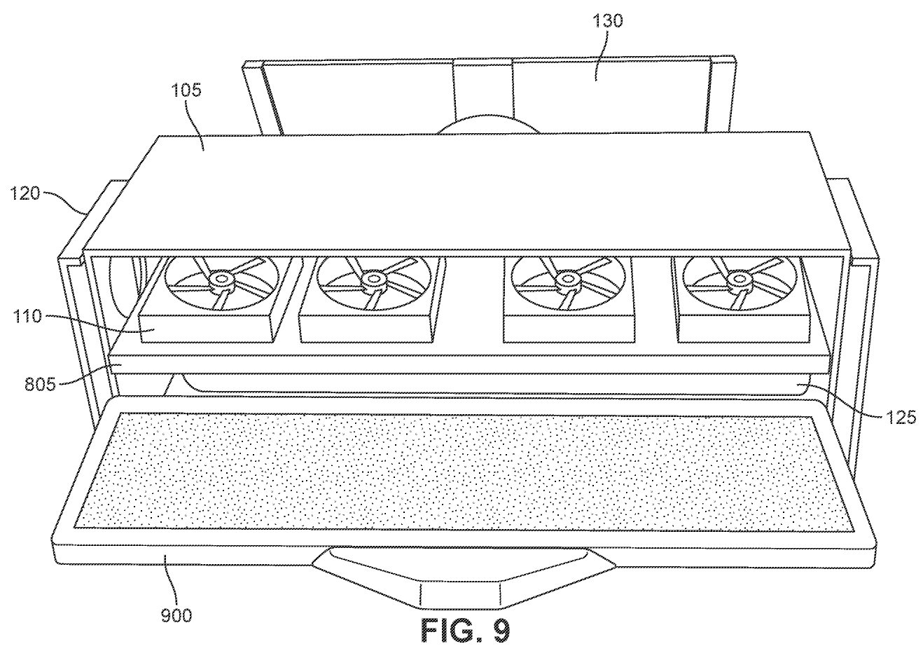

FIG. 9 is a schematic interior view of a fan unit illustrating a removable air filter. As illustrated in FIG. 9, fan unit 100 may include at least one removable air filter 900. Such filters may provide particulate filtration. Further, in some embodiments, such filters may be a carbon filter to remove smells and other contaminates from the air flow. Air filter 900 may be slidably inserted beneath partition 805.

In some embodiments, more than one fan unit may be used in a household to provide sophisticated airflow in order to regulate conditions within the house. For example, in some embodiments, one fan unit may be used for inflow, while another fan unit in a different part of the house may be used for exhaust. This not only draws air in from a certain side of the house providing a healthy air exchange of the air within the envelope of the house, but also it may move air from one room in the house to another room in the house.

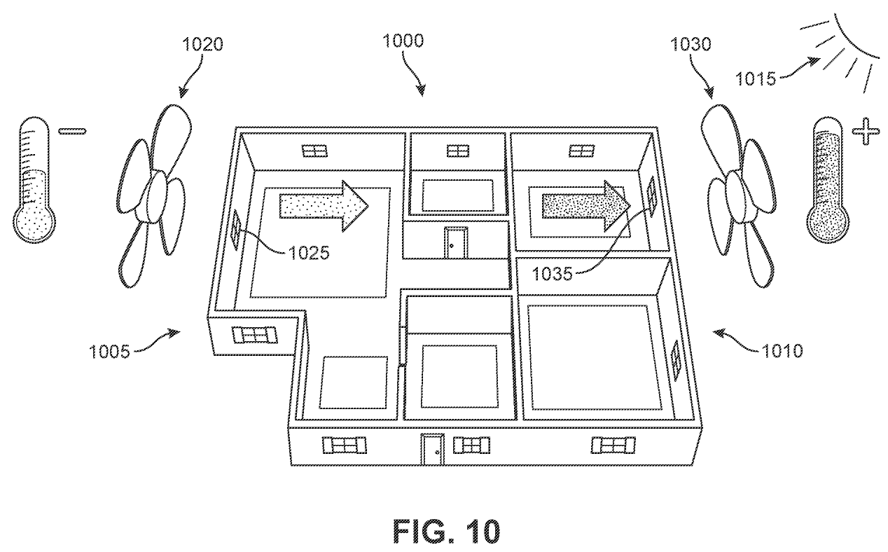

For example, multiple window-mounted fan units may be used together to regulate temperatures within a house to account for unbalanced interior temperatures due to uneven sun exposure. FIG. 10 is a schematic diagram of a house with a fan system including multiple window-mounted fan units. As shown in FIG. 10, a house 1000 having a first side 1005 and a second side 1010 is unevenly warmed by sun 1015 radiating from second side 1010 of house 1000. Accordingly, the temperature of the air on the shaded, first side of the house 1005 is significantly lower than the air on the second side 1010 of house 1000. This warmer air on the second side of the house, combined with the radiation of the sun on the side of the house, and the shining of sun through the windows makes the temperature inside the house on the second side 1010 much higher than on the first side 1005.

In order to even out the temperatures within house 1000, a first fan 1020 mounted in a first window 1025 may be used for inflow of cool air from shaded first side 1005 of house 1000, and a second fan 1030 in a second window 1035 may be used for exhaust of hot air from rooms on the second side 1010 of house 1000. This brings cool air into the house and exhausts hot air from the house, thus reducing the need to use air conditioning to cool the house. In addition, it evens out the temperatures throughout the house. It will be understood that any number of fans may be used around the house, in various combinations of inflow, outflow, and recirculation, to regulate conditions within the house.

In some configurations, multiple fan units may be utilized to provide a healthy air exchange. For example, one or more fan units may be used to exhaust air from the house our of one window, and one or more other fan units may be used to draw in fresh outside air from one or more other windows. Systems configured in this manner can turn over the air in the household envelope very quickly in order to provide a healthy environment for occupants.

In addition, in some embodiments, a system of one or more fan units may be controlled by a personal electronic device. In some embodiments, the personal electronic device may be a mobile device, such as a smart phone, tablet, laptop, etc. In other cases, the personal electronic device may be a desktop computer. In some cases, the fan system may be controlled by an application (app) on a mobile device, such as a smart phone. In other cases, the fan system may be controlled with a web-based interface.

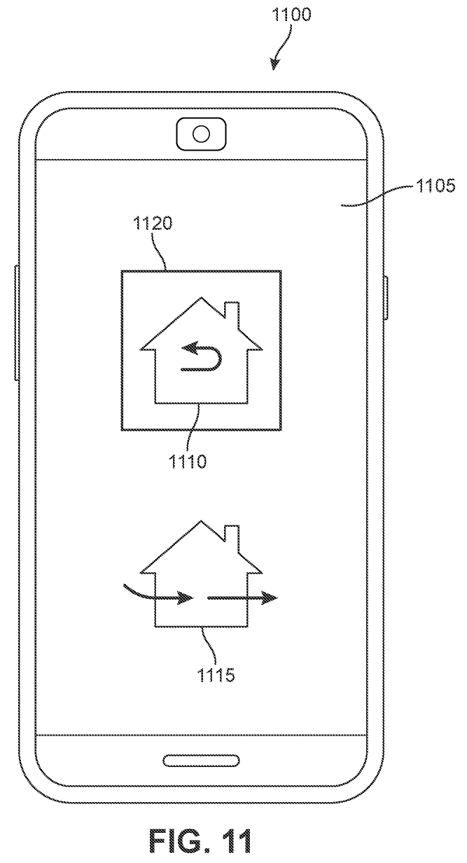

FIG. 11 is a schematic view of a personal electronic device with graphics associated with controlling operation of a fan system according to an embodiment. As shown in FIG. 11, a personal electronic device 1100 may have a graphical user interface 1105. In an exemplary illustration of selectable controls for the fan system, FIG. 11 illustrates the selection between recirculation (1110) and fresh air flow (1115). As shown in FIG. 11, a box 1120 indicates the current selection. It will be understood that any of the various settings and controls of the fan system may be controlled via personal electronic device. For example, functions such as fan speed, fan direction (intake, exhaust), recirculation, UV lamp operation, etc. may be controlled via personal electronic device.

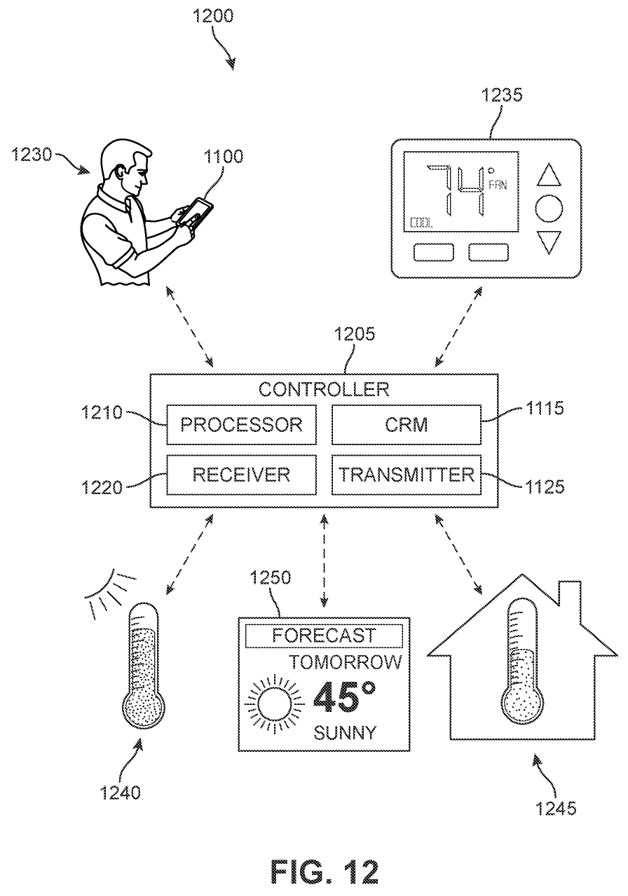

FIG. 12 is a schematic diagram of a fan system according to an embodiment. As illustrated in FIG. 12, a fan system 1200 may include a controller 1205. Controller 1205 may include various computing and communications hardware, such as servers, integrated circuits, displays, etc. Further, controller 1205 may include a device processor 1210 and a non-transitory computer readable medium 1215 including instructions executable by device processor 1210 to perform the processes discussed herein. In some embodiments, one or more components of controller 1205 may be incorporated into one or more of the fan units. In some embodiments, one or more components of controller 1205 may be incorporated into a personal electronic device. Further, in some embodiments, one or more components of controller 1205 may be located separate from fan units and the users personal electronic device. For example, in some cases, there may be a central unit located in the home that receives communications from the users personal electronic device and communicates with the individual fan units to control operation. In some embodiments, the computing may be performed at a remote location, such as a server hosted by a manufacturer.

The non-transitory computer readable medium may include any suitable computer readable medium, such as a memory, e.g., RAM, ROM, flash memory, or any other type of memory known in the art. In some embodiments, the non-transitory computer readable medium may include, for example, an electronic storage device, a magnetic storage device, an optical storage device, an electromagnetic storage device, a semiconductor storage device, or any suitable combination of such devices. More specific examples of the non-transitory computer readable medium may include a portable computer diskette, a floppy disk, a hard disk, a read-only memory (ROM), a random access memory (RAM), a static random access memory (SRAM), a portable compact disc read-only memory (CD-ROM), an erasable programmable read-only memory (EPROM or Flash memory), a digital versatile disk (DVD), a memory stick, and any suitable combination of these exemplary media. A non-transitory computer readable medium, as used herein, is not to be construed as being transitory signals, such as radio waves or other freely propagating electromagnetic waves, electromagnetic waves propagating through a waveguide or other transmission media (e.g., light pulses passing through a fiber-optic cable), or electrical signals transmitted through a wire.

Instructions stored on the non-transitory computer readable medium for carrying out operations of the present invention may be instruction-set-architecture (ISA) instructions, assembler instructions, machine instructions, machine dependent instructions, microcode, firmware instructions, configuration data for integrated circuitry, state-setting data, or source code or object code written in any of one or more programming languages, including an object oriented programming language such as Smalltalk, C++, or suitable language, and procedural programming languages, such as the “C” programming language or similar programming languages.

Aspects of the present disclosure are described in association with figures illustrating flowcharts and/or block diagrams of methods, apparatus (systems), and computing products. It will be understood that each block of the flowcharts and/or block diagrams can be implemented by computer readable instructions. The flowcharts and block diagrams in the figures illustrate the architecture, functionality, and operation of possible implementations of various disclosed embodiments. Accordingly, each block in the flowchart or block diagrams may represent a module, segment, or portion of instructions. In some implementations, the functions set forth in the figures and claims may occur in an alternative order than listed and/or illustrated.

Controller 1205 may include networking hardware configured to interface with other nodes of a network, such as a LAN, WLAN, or other networks. In Further, controller 1205 may be configured to receive data from a plurality of sources and communicate information to one or more external destinations. Accordingly, controller 1205 may include a receiver 1220 and a transmitter 1225. (It will be appreciated that, in some embodiments, the receiver and transmitter may be combined in a transceiver.) In some cases, communications between components may be made via the Internet, a cellular network, or other suitable communications network.

Any suitable communication platforms and/or protocols may be utilized for communication between controller 1205 and other components of the system. Since the various sources of information may each have their own platform and/or protocol, system 1200 may be configured to interface with each platform and/or protocol to receive the data. Thus, FIG. 12 illustrates the arrow showing communication between user 1230 and controller 1205 as a double-headed arrow, indicating two-way communication.

Computer readable medium 1215 may include instructions for receiving current weather data (1240) and controlling operation of the at least one fan unit based, at least in part, on the received current weather data. Such weather data may include any weather information, such as temperature, humidity, precipitation, wind speed and direction, heat index, air quality, etc. In addition, computer readable medium 1215 may include instructions for receiving current indoor ambient conditions data (1245) and controlling operation of the at least one fan unit based, at least in part, on the received current indoor ambient conditions data. The indoor ambient conditions data may include any conditions information including temperature, humidity, contaminants, etc. Accordingly, system 1200 may include various indoor and/or outdoor sensors for detecting ambient and/or weather conditions. Further, computer readable medium 1215 may include instructions for receiving indoor thermostat data (1235) and controlling operation of the at least one fan unit based, at least in part, on the received indoor thermostat data.

Also, in some embodiments, computer readable medium may include instructions to receive weather forecast data (1250) and control operation of the at least one fan unit based, at least in part, on the received weather forecast data. That is, the fan unit(s) may be controlled presently based on information about the predicted weather in the future. An example of this may be that, if hot weather is predicted during the day, the fan units may be operated in the early hours of the morning to pull in cool air before the sun comes up. This may significantly reduce the need for air conditioning for a significant portion of the daytime.

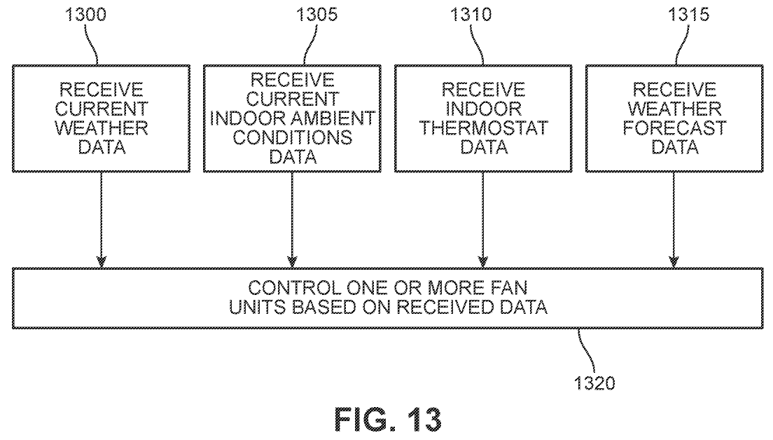

FIG. 13 is a flowchart illustrating a method of controlling a fan unit based on a variety of received data inputs. As shown in FIG. 13, the controller having a device processor and a non-transitory computer readable medium may include instructions, executable by the device processor, for receiving current weather data (step 1300), receiving current indoor ambient conditions data (step 1305), receiving indoor thermostat data (step 1310), and receiving weather forecast data (step 1315). In addition, the system may be configured for controlling one or more fan units based on the received data (step 1320).

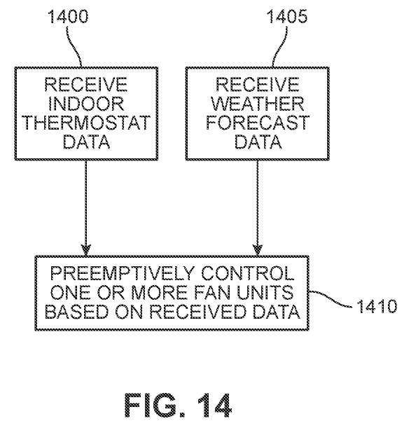

FIG. 14 is a flowchart illustrating a method of controlling a fan unit based on received weather forecast data. As shown in FIG. 14, the controller having a device processor and a non-transitory computer readable medium may include instructions, executable by the device processor, for receiving indoor thermostat data (step 1400) and receiving weather forecast data (step 1405). In addition, the computer readable medium may include instructions for preemptively controlling one or more fan units based on the received data.

While various embodiments are described, the description is intended to be exemplary, rather than limiting and it will be apparent to those of ordinary skill in the art that many more embodiments and implementations are possible that are within the scope of the disclosed embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted. Further, unless otherwise specified, any step in a method or function of a system may take place in any relative order in relation to any other step described herein.

What is claimed is:

1. A fan system, comprising:
at least one fan unit configured to be mounted in a window opening, the at least one fan unit including a blower unit configured to blow air through the window opening;
a controller including a device processor and a computer readable medium having stored thereon instructions, executable by the device processor, for performing the following steps:
receiving weather forecast data; and
controlling operation of the at least one fan unit based on the received weather forecast data.

2. The fan system of claim 1, wherein the computer readable medium further includes instructions for:
receiving current weather data; and
controlling operation of the at least one fan unit based, at least in part, on the received current weather data.

3. The fan system of claim 1, wherein the computer readable medium further includes instructions for:
receiving current indoor ambient conditions data; and
controlling operation of the at least one fan unit based, at least in part, on the received current indoor ambient conditions data.

4. The fan system of claim 1, wherein the computer readable medium further includes instructions for:
receiving indoor thermostat data; and
controlling operation of the at least one fan unit based, at least in part, on the received indoor thermostat data.

5. The fan system of claim 1, wherein the at least one fan unit has a substantially U-shaped configuration for mounting around an edge of the window.

6. The fan system of claim 1, wherein the direction of flow of the at least one fan unit is reversible.

7. The fan system of claim 1, wherein the at least one fan unit is configurable to recirculate air within a compartment enclosed by the window.

8. A window-mounted fan unit, comprising:
a trans-window duct configured to permit flow of air between a window edge and a window frame; and
a housing including one or more blower units and a movable air flow director configured to selectively determine whether air delivered through the one or more blower units is drawn from a first side of the window or from a second side of the window.

9. The fan unit of claim 8, further including an ultraviolet (UV) lamp for disinfecting airflow through the fan unit.

10. The fan unit of claim 8, further including a solar panel configured to power the one or more blower units, such that the fan unit is self-contained and thus operable independent of a household power source.

11. The fan unit of claim 8, wherein the air flow director has a crescent shaped cross-section and is rotatable from a first position in which air flow is permitted between the first side of the window and the second side of the window and a second position in which air flow is received from, and recirculated to, the first side of the window.

12. The fan unit of claim 8, further including an air guide partially surrounding the housing thereby forming an airflow passage between the housing and the air guide.

13. The fan unit of claim 8, further including one or more suction cups configured to secure the fan to a window.

14. The fan unit of claim 8, wherein the fan unit has a substantially U-shaped configuration for mounting around an edge of the window.

15. The fan unit of claim 8, wherein the direction of flow of the fan unit is reversible.

16. The fan unit of claim 8, wherein the fan unit is configurable to recirculate air within a compartment enclosed by the window.

17. A method of operating a fan system, comprising:
with a controller having a device processor and a non-transitory computer readable medium including instructions executable by the device processor,
receiving weather forecast data; and
based on the received weather forecast data, controlling operation of at least one fan unit configured to be mounted in a window opening, the at least one fan unit including a blower module configured to blow air through the window opening.

18. The method of claim 17, further including:
with the controller,
receiving current weather data; and
controlling operation of the at least one fan unit based, at least in part, on the received current weather data.

19. The method of claim 17, further including:
with the controller,
receiving current indoor ambient conditions data; and
controlling operation of the at least one fan unit based, at least in part, on the received current indoor ambient conditions data.

20. The method of claim 17, further including:
with the controller,
receiving indoor thermostat data; and
controlling operation of the at least one fan unit based, at least in part, on the received indoor thermostat data.
